(19) United States
(12) Patent Application Publication
(10) Pub. No.: US 2019/0207295 A1
(43) Pub. Date: Jul. 4, 2019

(54) INSTALLATION BODY AND INSTALLATION SYSTEM

(71) Applicant: NEC Platforms, Ltd., Kawasaki-shi, Kanagawa (JP)

(72) Inventor: Ken MIURA, Kanagawa (JP)

(73) Assignee: NEC Platforms, Ltd., Kawasaki-shi, Kanagawa (JP)

(21) Appl. No.: 16/303,237

(22) PCT Filed: May 22, 2017
(86) PCT No.: PCT/JP2017/018951

§ 371 Date: Nov. 20, 2018

(30) Foreign Application Priority Data
May 27, 2016 (JP) 2016-106391

(51) Int. Cl. H01Q 1/24; H01Q 19/22

(52) U.S. Cl. CPC H01Q 1/24; H04B 1/3877; H01Q 19/22

(57) ABSTRACT

The present invention addresses the problem of providing an installation body that, irrespective of the relative angle between a transmitter and a receiver, enables reduction in size and thickness of the transmitter and simultaneously enables improving of the probability of being able to achieve better reception of radio waves transmitted by the transmitter. In order to solve this problem, the installation body according to the present invention is provided with a conductor that is located in the vicinity of an antenna of the transmitter, in a state in which the transmitter is disposed in proximity to the installation body. The conductor is configured such that an induction current is generated therein by a drive current of the antenna. The induction current has a current component in a direction different from the direction of the drive current.

### TECHNICAL FIELD

The present invention relates to an installation body located in the vicinity of an antenna.

### BACKGROUND ART

A portable wireless apparatus is often used to perform short-range communication by a wireless local area network (LAN) and the like with another portable wireless apparatus. The portable wireless apparatus includes an antenna for the short-range communication. In recent years, size and thickness of portable wireless apparatuses have been reduced, and thus size and thickness of antennas have also been reduced.

Herein, PTL 1 discloses an antenna directivity control system that includes a radiating element being supplied with power by being electromagnetically coupled to a feed element and functioning as a radiating conductor, adjusts an amplitude of a signal at each feed point, and controls directivity of the antenna.

Further, PTL 2 discloses a mounting stand that allows a portable wireless device including an antenna for performing wireless communication to be mounted thereon in any position.

### CITATION LIST

### Patent Literature

[PTL 1] International Patent Publication No. WO2015/108133
[PTL 2] Japanese Unexamined Patent Application Publication No. 2013-214866

### SUMMARY OF INVENTION

### Technical Problem

Performance of the antenna decreases due to reduction in size and thickness of the short-range communication antenna. Thus, with some communication distance, good reception may not be performed by a receiver depending on a relative relationship between a set direction of a transmitter and a set direction of the receiver. However, there are many situations where it is desirable to achieve both reduction in size and thickness of an antenna and securing of performance. As an example, users who use a mobile router being a portable wireless apparatus as a home router at home have been recently increasing. In this case, it is desirable that other wireless apparatus terminals in various directions are able to perform good reception of a radio wave sent from the mobile router.

The antenna directivity control system disclosed in PTL 1 includes a radiating element located away from a feed element inside a transmitter. However, it is assumed that the antenna directivity control system disclosed in PTL 1 can control directivity of an antenna, but cannot make transmitted radio waves into multiple polarized waves. In this case, the antenna directivity control system disclosed in PTL 1 cannot perform good reception of a radio wave transmitted from the transmitter regardless of a relative angle between the transmitter and the receiver. Furthermore, the antenna directivity control system disclosed in PTL 1 includes the radiating element located away from the feed element inside the transmitter, and thus it is difficult to achieve reduction in size and thickness of the transmitter.

An object of the present invention is to provide an installation body capable of achieving both reduction in size and thickness of a transmitter and improvement in a probability that better reception of a radio wave transmitted from the transmitter regardless of a relative angle between the transmitter and a receiver can be achieved.

### Solution to Problem

An installation body according to the present invention includes a conductor located in a vicinity of an antenna provided in a transmitter in a state where the transmitter is located in proximity to the installation body. An induction current is generated by a drive current of the antenna in the conductor. The induction current has a current component in a direction different from a direction of the drive current.

### Advantageous Effects of Invention

An installation body according to the present invention can achieve both reduction in size and thickness of a transmitter and improvement in a probability that better reception of a radio wave transmitted from the transmitter regardless of a relative angle between the transmitter and a receiver.

### BRIEF DESCRIPTION OF DRAWINGS

FIG. 1 is a perspective schematic diagram (part one) illustrating an example of an installation body in a first example embodiment.

FIG. 2 is a perspective schematic diagram (part two) illustrating an example of the installation body in the first example embodiment.

FIG. 3 is an enlarged schematic diagram of a conductor.

FIG. 4 is a perspective schematic diagram illustrating an example of an antenna.

FIG. 5 is a diagram illustrating a positional relationship between the antenna and the conductor.

FIG. 6 is a diagram illustrating dimensions of a substrate, the antenna, the conductor, and the like used for calculation.

FIG. 7 is a diagram illustrating an example of a calculation result of an impedance and a return loss of the antenna in a configuration in which the conductor is eliminated.

FIG. 8 is a diagram illustrating an example of a calculation result of an impedance and a return loss of the antenna and the conductor in combination.

FIG. 9 is a diagram illustrating an example of a calculation result of radio wave intensity of a vertical polarized wave and a horizontal polarized wave, assuming that a radio wave is emitted from the antenna in the configuration in which the conductor is eliminated.

FIG. 10 is a diagram illustrating an example of a calculation result of radio wave intensity of a vertical polarized wave and a horizontal polarized wave, assuming that a radio wave is emitted from the antenna in the configuration illustrated in FIG. 5.

FIG. 11 is an image diagram illustrating reasons why radio wave intensity of a vertical polarized wave improves when the conductor is provided.

FIG. 12 is a diagram illustrating an example of a calculation result of radiation efficiency of the antenna in the configuration in which the conductor is eliminated.

FIG. 13 is a perspective schematic diagram illustrating examples of conductors that may be applied to an installation body in a second example embodiment.

FIG. 14 is a perspective schematic diagram illustrating an example of a plurality of conductors provided in an installation body in a third example embodiment.

FIG. 15 is a diagram illustrating an example of a computation result of radiation efficiency of antennas illustrated in FIG. 14.

FIG. 16 is a diagram illustrating a calculation result of a frequency characteristic of an isolation, which is a leak of a signal from an antenna 111b to an antenna 111c illustrated in FIG. 14.

FIG. 17 is a diagram illustrating a calculation result of a coefficient of correlation between a radiation pattern of the antenna 111b and a radiation pattern of the antenna 111c.

FIG. 18 is a schematic diagram illustrating an example of a minimum configuration of an installation body in the present invention.

### EXAMPLE EMBODIMENT

### First Example Embodiment

A first example embodiment is an example embodiment for an installation body including a conductor that emits a radio wave with an induction current generated by a drive current of an antenna provided in a transmitter.

### [Configuration and Operation]

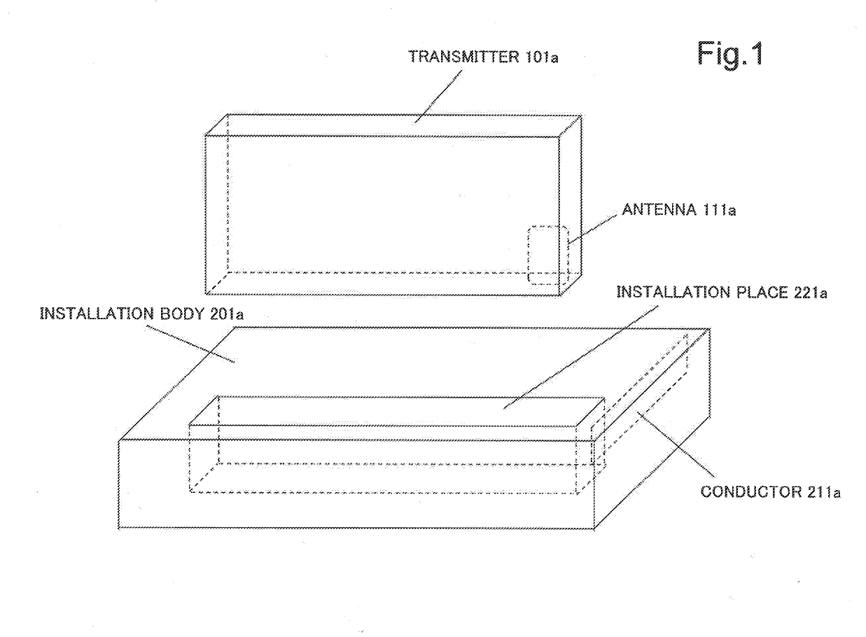

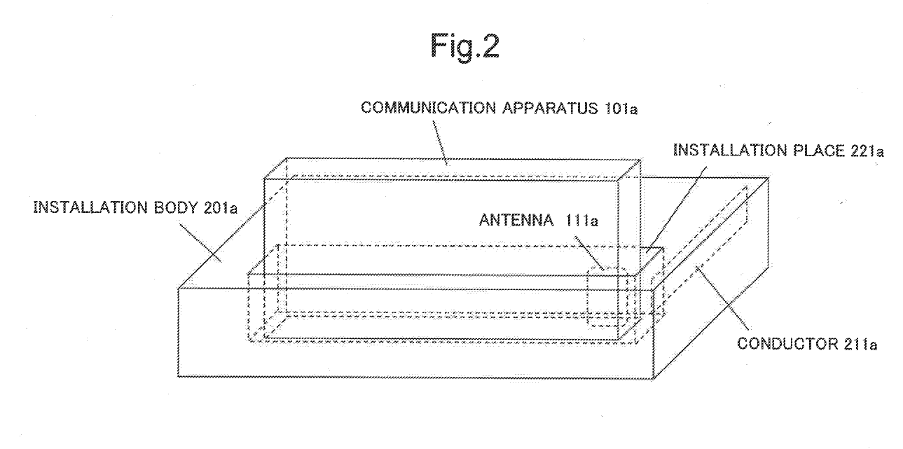

FIGS. 1 and 2 are perspective schematic diagrams illustrating an installation body 201a being an example of an installation body in the first example embodiment. FIGS. 1 and 2 also illustrate a transmitter 101a being an example of a transmitter. Note that, up, down, left, and right represent up, down, left, and right as seen from the front of each diagram in the following description.

The transmitter 101a includes, at an end portion, an antenna 111a for transmitting a radio wave to another transmitter when transmission to the other transmitter is performed. The antenna 111a is installed in such a way that an up-and-down direction is a longitudinal direction of the antenna 111a. Note that, the antenna 111a may be an antenna formed on a substrate, an antenna formed on a chip and the like, or an antenna being a single element.

The installation body 201a includes an installation place 221a that allows the transmitter 101a to be installed therein. FIG. 1 illustrates a state where the transmitter 101a is not installed in the installation place 221a. FIG. 2 illustrates a state where the transmitter 101a is installed in the installation place 221a in such a way that a part of a lower portion of the transmitter 101a is housed in the installation place 221a.

A conductor 211a is installed in the vicinity of a right end portion of the installation body 201a. The conductor 211a is, for example, a thin plate or a film made of metal. For example, the conductor 211a can be formed by being cut from a metal plate. Alternatively, the conductor 211a can be formed by forming a metal thin film on a predetermined substrate by deposition, sputtering, and the like. The conductor 211a is located in the vicinity of the antenna 111a in the state illustrated in FIG. 2.

Note that, FIGS. 1 and 2 illustrate the case where the conductor 211a is installed inside the installation body 201a, but the conductor 211a may be installed on a surface of the installation body 201a. Further, at least a part of the conductor 211a may be exposed from the installation place 221a.

Further, the installation body 201a can have any shape and size as long as the installation body 201a allows the transmitter 101a to be installed thereon and the conductor 211a to be provided thereon.

The installation body 201a is, for example, a cradle used when the transmitter 101a is charged and when communication is performed, and an installation stand that allows the transmitter 101a to be installed thereon.

The transmitter 101a is, for example, a mobile router.

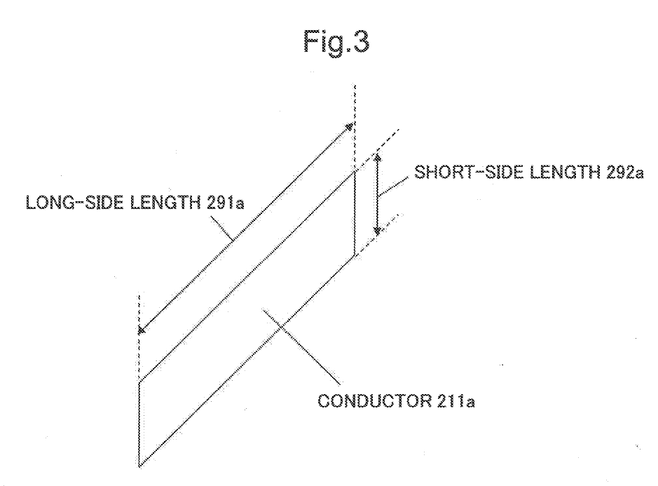

FIG. 3 is an enlarged schematic diagram in which the conductor 211a illustrated in FIGS. 1 and 2 is assumed to be in a direction identical to the direction illustrated in FIGS. 1 and 2. The conductor 211a is a rectangle having a long-side length 291a and a short-side length 292a.

In order to cause the conductor 211a to resonate with a current (and a radio wave generated by the current) flowing through the antenna 111a, the long-side length 291a is about a half a wavelength of the radio wave. However, it may be more preferable that the long-side length 291a is slightly deviated from a half the wavelength of the radio wave due to an influence of a casing, a peripheral component, and the like.

On the other hand, the short-side length 292a has a value that needs to be adjusted depending on a distance between the antenna 111a and the conductor 211a. As the distance increases, it is more difficult for a radio wave emitted from the antenna 111a to generate a resonance current inside the conductor 211a, but resonance may be achieved by increasing the short-side length 292a in some cases.

When a resonance current is generated by a radio wave emitted from the antenna 111a inside the conductor 211a, the conductor 211a operates as an antenna. Thus, a radio wave at the same frequency emitted from the conductor 211a is superimposed on a radio wave emitted from the antenna 111a, and a characteristic of a radio wave and a reception characteristic of a receiver may be improved, as described later.

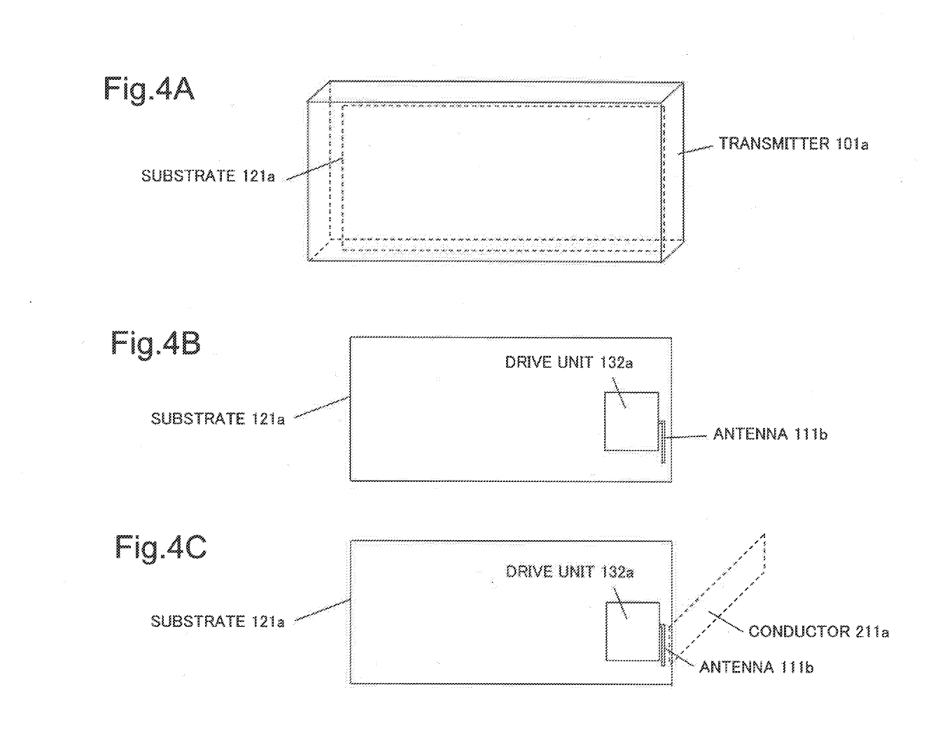

FIG. 4 is a perspective schematic diagram illustrating an antenna 111b being an example of the antenna 111a installed in the transmitter 101a illustrated in FIGS. 1 and 2.

The antenna 111b is called an inverted L-shaped antenna.

The antenna 111b is installed on a substrate 121a installed in the transmitter 101a (see FIG. 4 (a)).

As illustrated in FIG. 4 (b), the antenna 111b is formed on the substrate 121a and connected to a drive unit 132a formed on the substrate 121a. The antenna 111b is driven by the drive unit 132a and emits a radio wave for communication. The antenna 111b is formed in such a way that a longitudinal direction of the antenna 111b except for a connection place with the drive unit 132a is an up-and-down direction.

FIG. 4 (c) is a schematic diagram illustrating a positional relationship between the antenna 111b and the conductor 211a illustrated in FIG. 2. The longitudinal direction of the antenna 111b is substantially vertical to the longitudinal direction of the conductor 211a. Further, it is more preferable that a surface of the substrate 121a is substantially vertical to a surface of the conductor 211a. The reason is that a bias in a radio wave obtained by superimposing the radio wave emitted from the antenna 111b on the radio wave emitted from the conductor 211a can be further reduced more frequently.

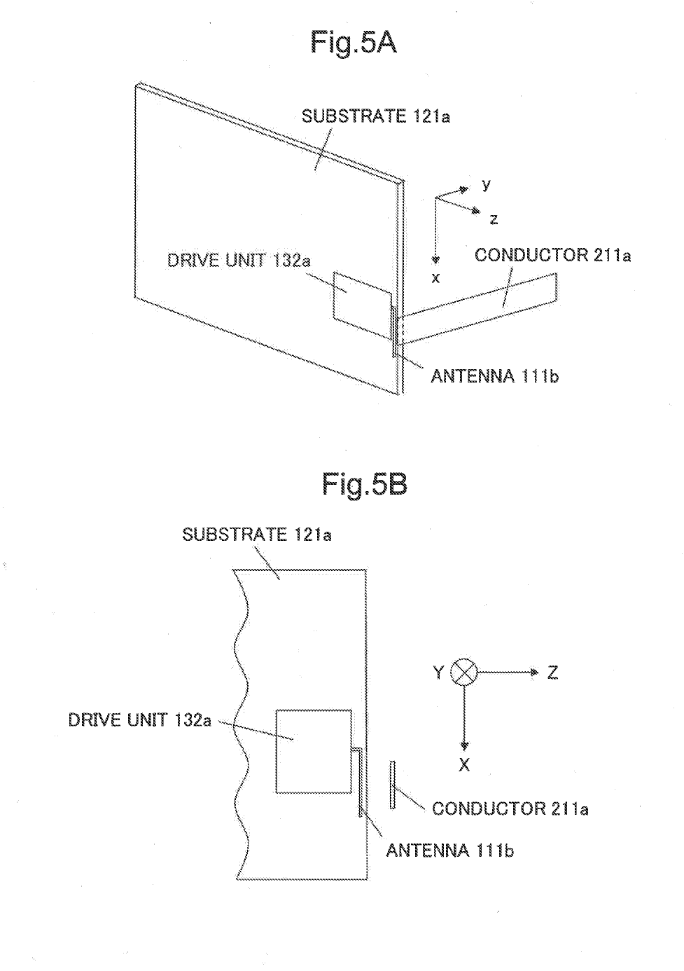

FIG. 5 is a diagram illustrating a positional relationship between the antenna 111b and the conductor 211a being used for calculation described below. FIG. 5 (a) is a perspective view. FIG. 5 (b) is a diagram on the assumption that an antenna formed on the substrate 121a is seen from a direction vertical to the surface of the substrate 121a. In FIG. 5 (b), a downward direction is a positive direction in an X direction, a direction vertical to the surface of the substrate 121a and directed from the front toward the back is a positive direction in a Y direction, and a direction toward the right is a positive direction in a Z direction. It is assumed that the longitudinal direction of the antenna 111b is vertical to the longitudinal direction of the conductor 211a, and the surface of the antenna 111b (that is, the surface of the substrate 121a) is vertical to the surface of the conductor 211a. It is also assumed that a frequency of a radio wave emitted from the antenna 111b is at a frequency of 2.4 GHz.

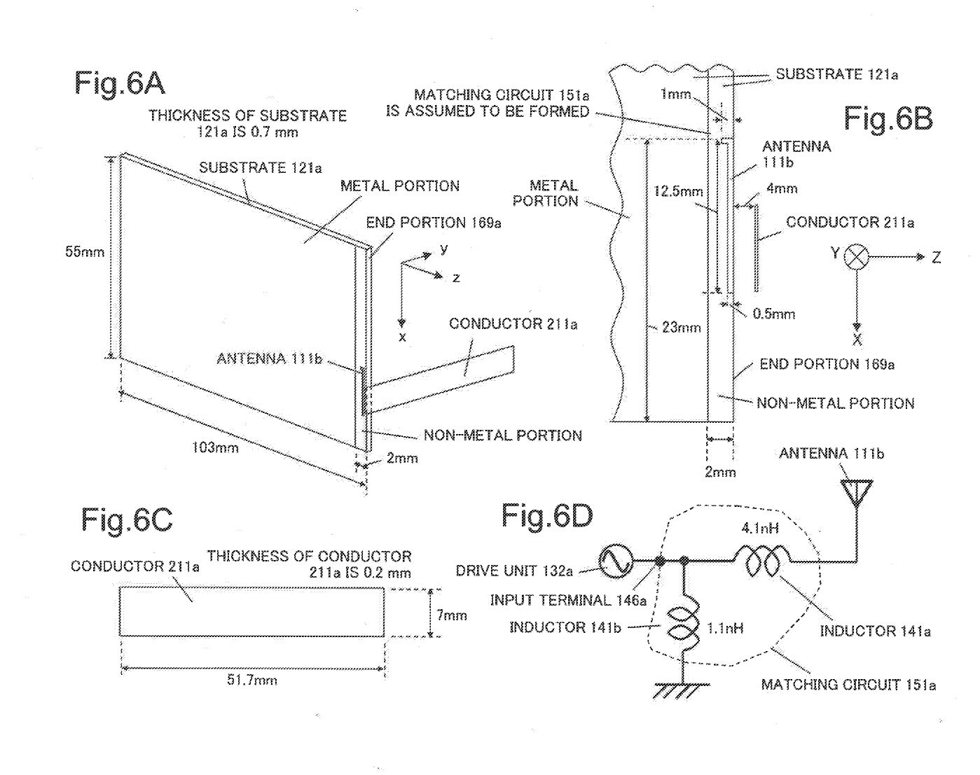

FIG. 6 is a diagram illustrating dimensions of the substrate, the antenna, the conductor, and the like used for calculation described below.

As illustrated in FIG. 6 (a), the substrate 121a is a rectangular parallelepiped plate having a width of 103 mm, a height of 55 mm, and a thickness of 0.7 mm. It is then assumed that the substrate 121a is metal except for a portion of 2 mm from an end portion 169a. An element forming portion of an actual substrate is covered with metal, but an approximation is made herein that the substrate is metal in consideration of ease of calculation. The approximation is conceivably appropriate from experience. Note that, the portion of 2 mm of the substrate 121a from the end portion 169a is an insulator.

As illustrated in FIG. 6 (b), the inverted L-shaped antenna 111b is formed on the substrate 121a in a range of 2 mm from the end portion 169a of the substrate 121a. The antenna 111b is a metal plate having a width of 0.5 mm and a thickness of 0.1 mm. Then, a longer linear portion of the antenna 111b has a length of 12.5 mm, and a shorter linear portion of the antenna 111b has a length of 1 mm.

A right end of the antenna 111b coincides with a right end of the substrate 121a. A distance between an upper end of the antenna 111b and a lower end of the substrate 121a is 12.5 mm.

Further, although the illustration is omitted, a matching circuit 151a described later is assumed to be formed between the shorter linear portion and the drive unit 132a. The matching circuit 151a is assumed to be formed in a non-metal place of the substrate 121a on the substrate 121a. The drive unit 132a illustrated in FIG. 5 is omitted from FIG. 6 (b). The drive unit 132a is assumed to be formed inside the metal portion of the substrate 121a on the substrate 121a.

A distance between the antenna 111b and the conductor 211a is 4 mm.

As illustrated in FIG. 6 (c), the conductor 211a is a rectangular parallelepiped having a width of 51.7 mm, a height of 7 mm, and a thickness of 0.2 mm. The conductor 211a is assumed to be metal.

FIG. 6 (d) is a diagram illustrating the matching circuit 151a described above. As described above, the matching circuit 151a is assumed to be formed between the drive unit 132a and the antenna 111b. Then, the matching circuit 151a includes an inductor 141a at 4.1 nH formed between the drive unit 132a and the antenna 111b and an inductor 141b at 1.1 nH formed between a connection portion of the drive unit 132a and the ground.

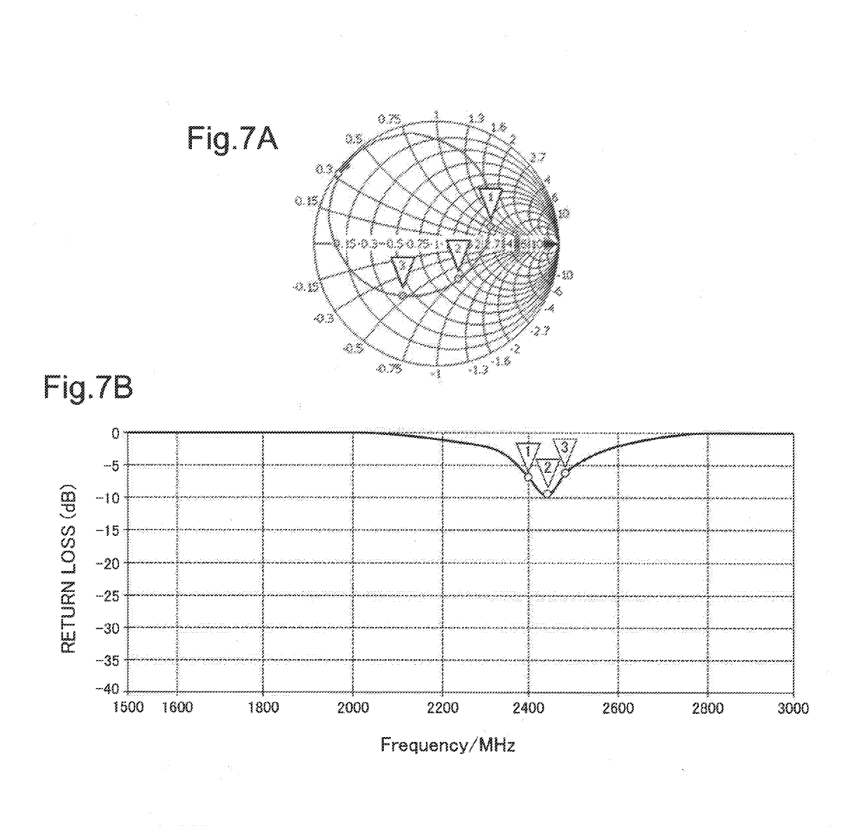

FIG. 7 is a diagram illustrating an example of a calculation result of an impedance and a return loss of the antenna 111b in a configuration in which the conductor 211a is eliminated from the configuration illustrated in FIG. 5. The return loss of the antenna 111b is a strength ratio of the antenna 111b through the matching circuit 151a to a reflected wave returning to the input terminal 146a from the antenna 111b through the matching circuit 151a to a traveling wave input from an input terminal 146a illustrated in FIG. 6 (d). FIG. 7 (a) is a Smith chart illustrating a relationship between the traveling wave input from the input terminal 146a illustrated in FIG. 6 (d) to the antenna 111b through the matching circuit 151a and the reflected wave returning to the input terminal 146a from the antenna 111b through the matching circuit 151a. FIG. 7 (b) is a frequency characteristic of a return loss derived from the Smith chart illustrated in FIG. 7 (a). Herein, a frequency indicated by a marker is a frequency of a radio wave emitted from the antenna 111b.

The configuration in which the conductor 211a is eliminated from the configuration illustrated in FIG. 5 corresponds to the configuration of the transmitter 101a that is not installed in the installation body 201a as illustrated in FIG. 1.

According to FIG. 7 (b), a return loss decreases near a frequency of 2440 MHz. The reason is that a shape of the antenna 111b is designed in such a way that the return loss is minimum at the frequency of 2440 MHz. However, a minimum value of the return loss is about −10 dB.

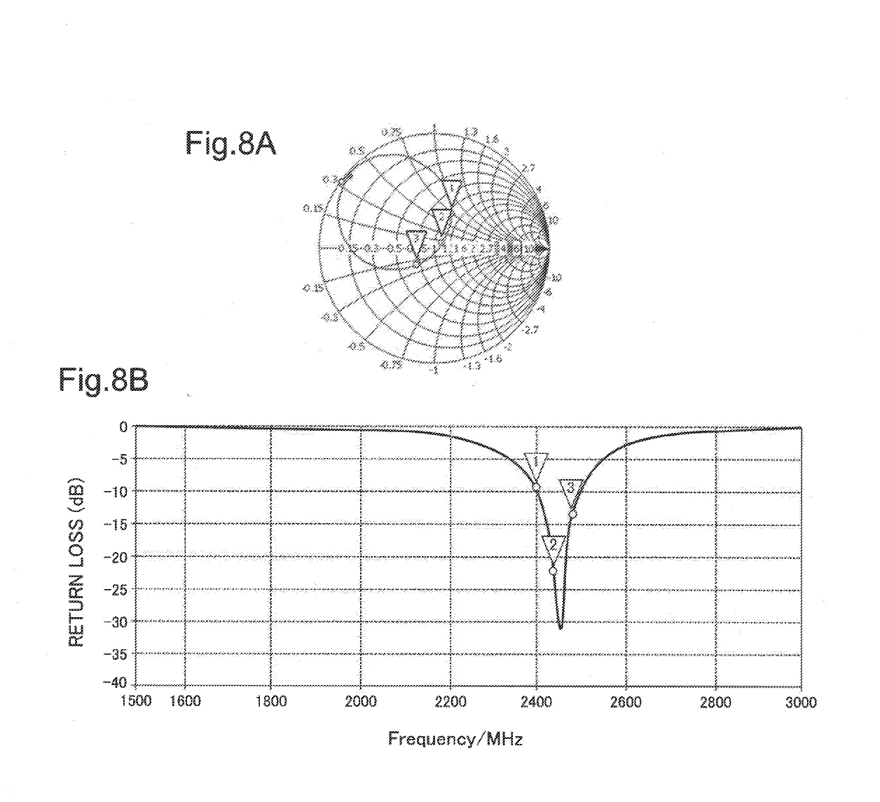

FIG. 8 is a diagram illustrating a calculation example of an impedance and a return loss of the antenna 111b and the conductor 211a in combination in the configuration illustrated in FIG. 5. FIG. 8 (a) is a Smith chart illustrating a relationship between a traveling wave input from the input terminal 146a illustrated in FIG. 6 (d) to the antenna 111b through the matching circuit 151a and a reflected wave returning to the input terminal 146a from the antenna 111b through the matching circuit 151a. FIG. 8 (b) is a frequency characteristic of a return loss derived from the Smith chart illustrated in FIG. 8 (a). The configuration illustrated in FIG. 5 corresponds to the configuration of the transmitter 101a installed in the installation body 201a as illustrated in FIG. 2.

According to FIG. 8 (b), a return loss is minimum near a frequency of 2455 MHz. A minimum value of the return loss is less than or equal to −30 dB, and it is clear that the minimum value is significantly smaller than the minimum value of the return loss illustrated in FIG. 7 (b).

The conductor 211a is provided in the vicinity of the antenna 111b as illustrated in FIG. 5, and thus it is clear that the return loss near 2430 MHz being a frequency of a radio wave emitted from the antenna 111b is greatly improved.

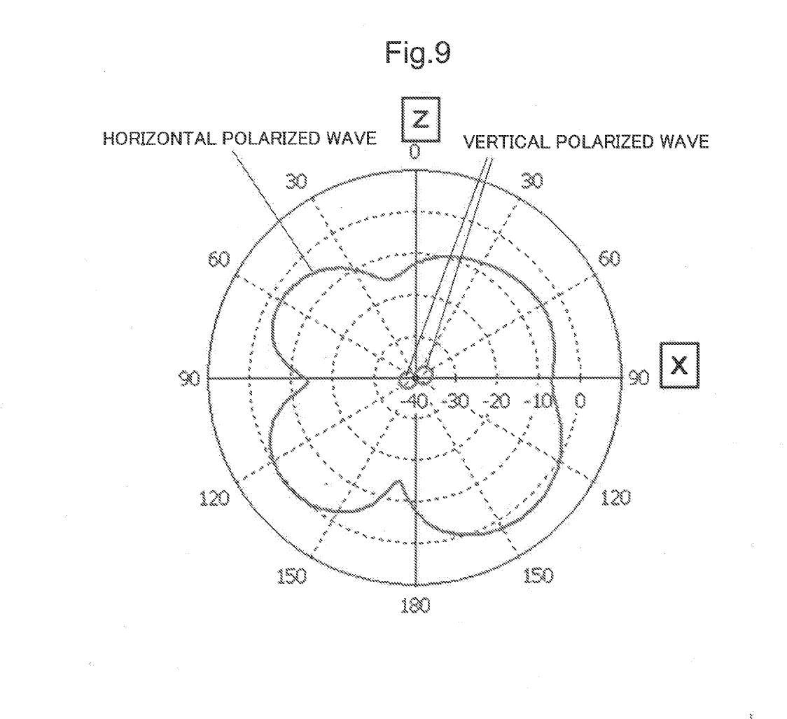

FIG. 9 is an example of a calculation result of a radiation pattern of a radio wave, assuming that the radio wave is emitted from the antenna 111b in the configuration in which the conductor 211a is eliminated from the configuration illustrated in FIG. 5. FIG. 9 is an example of a calculation result of radio wave intensity of a vertical polarized wave and a horizontal polarized wave. The radio wave intensity is calculated from a corresponding position in each direction in an X-Z plane. Herein, the X direction and the Z direction are as illustrated in FIG. 5.

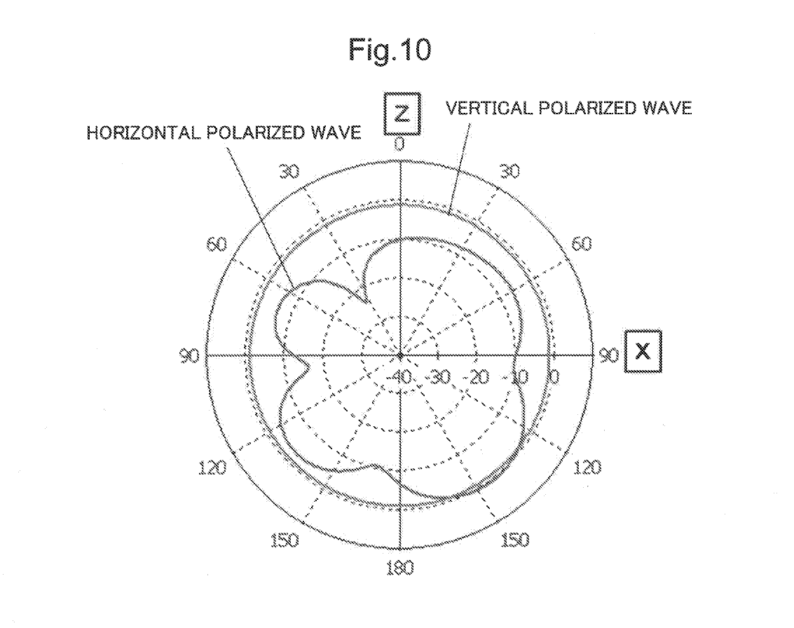

A distance between each point of a closed curved line indicating a horizontal polarized wave in FIG. 9 (and in FIG. 10 described later) and the center of a circle illustrated in FIG. 9 indicates radio wave intensity of the horizontal polarized wave in a direction connecting the point and the center in the X-Z plane. A distance between each point of a closed curved line indicating a vertical polarized wave in FIG. 9 (and in FIG. 10 described later) and the center of a circle illustrated in FIG. 9 (and in FIG. 10 described later) indicates radio wave intensity of the horizontal polarized wave in a direction connecting the point and the center in the X-Z plane. Herein, the horizontal polarized wave is a polarized wave in a horizontal direction with respect to the substrate 121a. Further, the vertical polarized wave is a polarized wave in a vertical direction with respect to the substrate 121a. A unit of the radio wave intensity is dBi. However, a numerical value indicating the radio wave intensity in FIG. 9 (and in FIG. 10 described later) is a relative value and is not a meaningful numerical value itself.

According to FIG. 9, the horizontal polarized wave has magnitude of the radio wave intensity to some extent in all directions in the X-Z plane. On the other hand, it is clear that the vertical polarized wave has extremely small radio wave intensity in all directions in the X-Z plane.

FIG. 10 illustrates an example of a calculation result of a radiation pattern of a radio wave, assuming that the radio wave is emitted from the antenna 111b in the configuration illustrated in FIG. 5. FIG. 10 is an example of a calculation result of radio wave intensity of a vertical polarized wave and a horizontal polarized wave. The radio wave intensity is calculated in each direction, assuming that the antenna 111b is rotated in the X-Z plane. Herein, the X direction and the Z direction are as illustrated in FIG. 5.

According to FIG. 9, the horizontal polarized wave has magnitude of the radio wave intensity to some extent in all directions in the X-Z plane. Meanwhile, the vertical polarized wave also has magnitude of the radio wave intensity to some extent in all directions in the X-Z plane.

In other words, the conductor 211a is provided as illustrated in FIG. 5, and thus it is clear that the radio wave intensity of the vertical polarized wave in each direction in the X-Z plane is greatly improved.

The improvement in the radio wave intensity of the vertical polarized wave in the position represents that, when a reception antenna of a certain receiver is placed in the position, a probability that the reception antenna is able to achieve good reception is improved regardless of a direction of the reception antenna.

The improvement in the radio wave intensity of the vertical polarized wave as illustrated in FIG. 10 is conceivable for the following reasons.

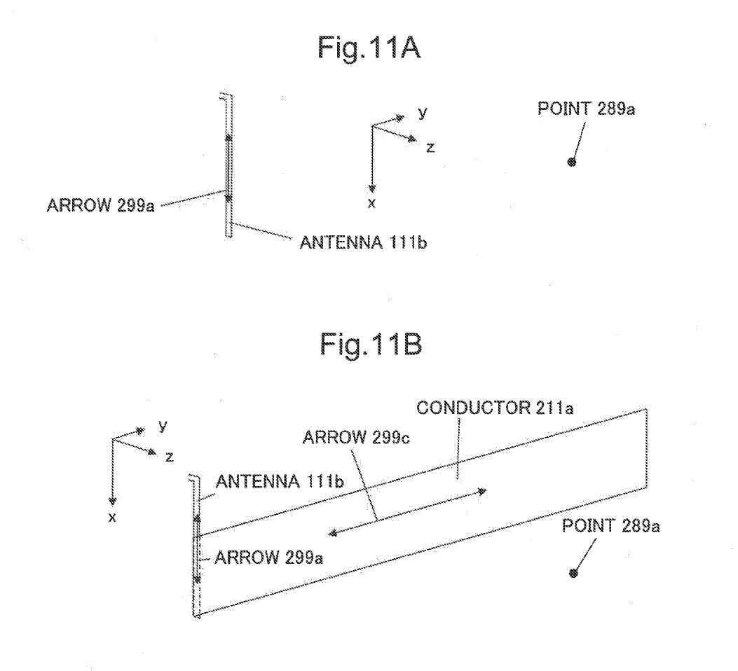

FIG. 11 is an image diagram illustrating reasons why the radio wave intensity of the vertical polarized wave is improved as illustrated in FIG. 10 when the conductor 211a is provided as illustrated in FIG. 5. FIG. 11 (a) illustrates a case without the conductor 211a. FIG. 11 (b) illustrates a case with the conductor 211a.

In the case illustrated in FIG. 11 (a), a drive current is applied to the antenna 111b in a direction of an arrow 299a. The drive current is an alternating current driven by the drive unit 132a illustrated in FIG. 5. Since the drive current mainly flows in the x direction, the horizontal polarized wave has magnitude of radio wave intensity to some extent in all directions in the x-z plane at a point 289a. However, a situation where there is hardly any radio wave intensity of the vertical polarized wave occurs.

On the other hand, in the case of FIG. 11 (b), the drive current flowing through the antenna 111b in the direction of the arrow 299a generates a resonance current (induction current) in a direction including the direction of an arrow 299c inside the conductor 211a. This resonance current is generated when the long-side length of the conductor 211a is substantially half a wavelength of a radio wave emitted from the antenna 111b. Then, a radio wave obtained by superimposing a radio wave generated by the drive current flowing through the antenna 111b in the direction of the arrow 299a on a radio wave by the resonance current flowing through the conductor 211a reaches the point 289a. The arrow 299a is orthogonal to the arrow 299c. Thus, a horizontal polarized wave and a vertical polarized wave are observed in each direction in the x-z plane at the point 289a. The horizontal polarized wave is mainly a radio wave generated by the current flowing through the antenna 111b in the direction of the arrow 299a. Further, the vertical polarized wave is mainly a radio wave generated by the resonance current flowing through the conductor 211a in the direction of the arrow 299c.

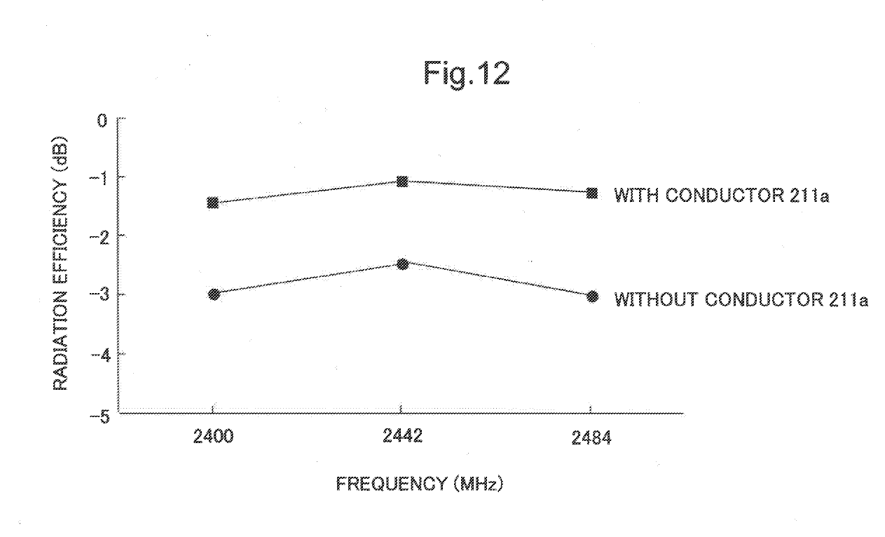

FIG. 12 is a diagram illustrating an example of a calculation result of radiation efficiency of the antenna 111b in each of the configuration illustrated in FIG. 5 and the configuration in which the conductor 211a is eliminated from the configuration illustrated in FIG. 5. Herein, the radiation efficiency of the antenna 111b is a ratio of the entire radiated power from the antenna 111b to supplied power to the antenna 111b.

It is clear that the radiation efficiency of the antenna 111b is further improved with the conductor 211a than without the conductor 211a in a frequency range illustrated in FIG. 12.

As described above, the installation body 201a with the transmitter 101a installed therein includes the conductor 211a located in the vicinity of the antenna 111a of the transmitter 101a. The conductor 211a has a long side having a length that is substantially half a wavelength of a radio wave emitted from the antenna 111a. Then, the long side is substantially vertical to the antenna 111a. In this case, the resonance current is generated in the longitudinal direction of the conductor 211a by the drive current flowing through the antenna 111a. Then, a radio wave obtained by superimposing a radio wave generated by the drive current flowing through the antenna 111a on a radio wave generated by the resonance current flowing through the conductor 211a is emitted from the antenna 111a and the conductor 211a in combination. Thus, the horizontal polarized wave and the vertical polarized wave having sufficient intensity are obtained in a reception position of the receiver. Therefore, the installation body 201a can improve the probability that the receiver is able to achieve good reception of a radio wave transmitted from the transmitter 101a regardless of an angle of installation of the antenna provided in the receiver.

Note that, the installation body housing a part of the communication apparatus as illustrated in FIG. 1 is described in the description above. However, the installation body in the present example embodiment may house the entire communication apparatus, or may only allow the communication apparatus to be installed and not house a part of the communication apparatus. Furthermore, the installation body in the present example embodiment may be installed or housed in the communication apparatus or may simply be combined with a communication device.

The case where the antenna provided in the transmitter is the inverted L-shaped antenna is described as an example in the description above. However, the antenna provided in the transmitter may be an L-shaped antenna, or furthermore, may be another antenna.

### Advantageous Effect

The installation body in the first example embodiment with the transmitter installed therein includes the conductor in the vicinity of the antenna of the transmitter. The conductor has a long side having a length that is substantially half a wavelength of a radio wave emitted from the antenna. Then, the long side is substantially vertical to the longitudinal direction of the antenna. In this case, a current that resonates with a current flowing through the antenna is generated in the longitudinal direction of the conductor. Then, a radio wave obtained by superimposing a radio wave generated by the current flowing through the antenna on a radio wave generated by the current flowing through the conductor is emitted from the antenna and the conductor in combination. Thus, the horizontal polarized wave and the vertical polarized wave having sufficient intensity are obtained in a reception position of the receiver. Therefore, the installation body in the first example embodiment can improve the probability that the receiver is able to achieve good reception of a radio wave transmitted from the transmitter regardless of an angle of installation of the antenna provided in the receiver.

Furthermore, since the conductor is located outside the transmitter, both of the above-described effects and reduction in size and thickness of the transmitter can be achieved.

### Second Example Embodiment

A second example embodiment is an example embodiment concerned with an installation body including a conductor having a bent shape.

### [Configuration and Operation]

A configuration example of the installation body in the second example embodiment is, for example, the installation body 201a illustrated in FIGS. 1 and 2 in which the conductor 211a is replaced with any of conductors 211b to 211d described next. Further, a configuration example of a transmitter used in combination with the installation body in the second example embodiment is the transmitter 101a illustrated in FIGS. 1 and 2 in which the antenna 111a is replaced with an antenna described next.

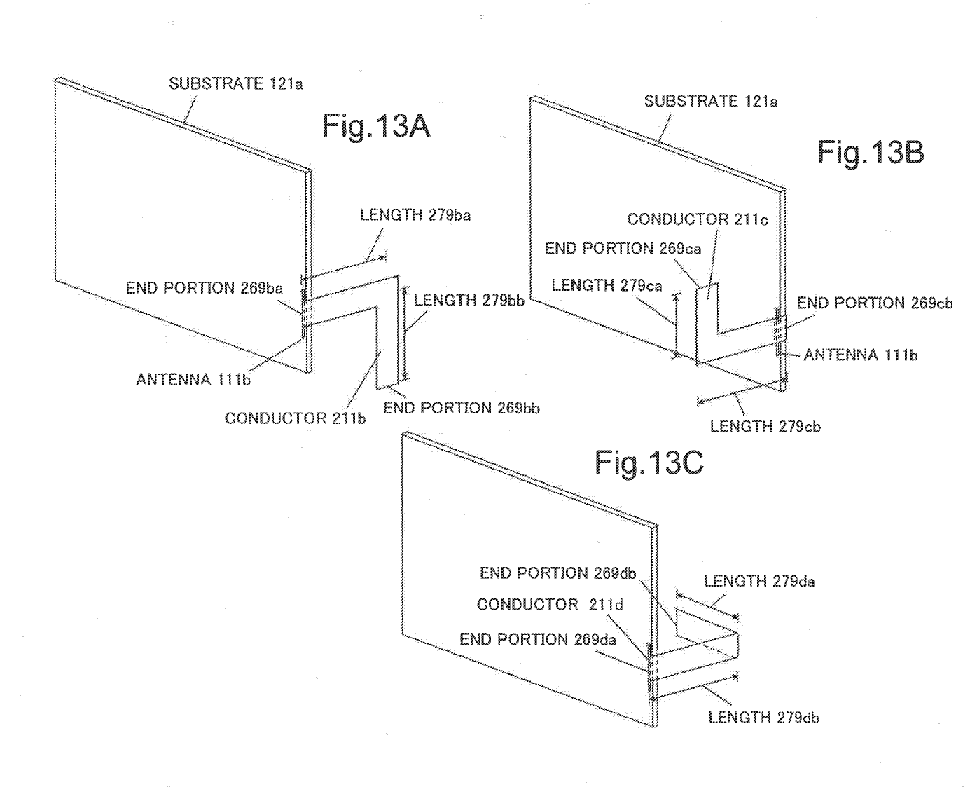

FIG. 13 is a perspective schematic diagram illustrating examples of conductors that may be applied to the installation body in the second example embodiment. FIG. 13 illustrates the antenna 111b and the substrate 121a together in a state where the transmitter 101a illustrated in FIG. 1 is installed in the installation body in the second example embodiment.

As illustrated in FIG. 13, various conductors having a bent shape can be used as a conductor that may be applied to the installation body in the second example embodiment.

A length of a current path between an end portion 269ba and an end portion 269bb in the conductor 211b, that is, a sum of a length 279ba and a length 279bb is about half a wavelength of a radio wave emitted from the antenna 111b. The reason is that the resonance current generated in the conductor 211b by the drive current flowing through the antenna 111b causes a radio wave to be generated in the current path between the end portion 269ba and the end portion 269bb.

Further, a length of a current path between an end portion 269ca and an end portion 269cb in the conductor 211c, that is, a sum of a length 279ca and a length 279cb is about half the wavelength of the radio wave emitted from the antenna 111b. The reason is that the resonance current generated in the conductor 211c by the drive current flowing through the antenna 111b causes a radio wave to be generated in the current path between the end portion 269ca and the end portion 269cb.

Further, a length of a current path between an end portion 269da and an end portion 269db in the conductor 211d, that is, a sum of a length 279da and a length 279db is about half the wavelength of the radio wave emitted from the antenna 111b. The reason is that the resonance current generated in the conductor 211d by the drive current flowing through the antenna 111b causes a radio wave to be generated in the current path between the end portion 269da and the end portion 269db.

Note that, FIG. 13 illustrates the conductors having a shape bent at only one place. However, the conductor may be bent at three or more places as long as a length of a current path between end portions is about half the wavelength of the radio wave emitted from the antenna 111b.

Since the conductor 211a illustrated in FIGS. 1 and 2 is a rectangle, at least a length of the long side is about half the wavelength of the radio wave emitted from the antenna 111a (or 111b). Thus, to install the conductor 211a in the installation body, a large portion that allows the rectangular conductor 211a to be installed in the vicinity of the antenna 111a (or 111b) may need to be secured.

On the other hand, the conductor in the second example embodiment has a bent shape, and thus a maximum length can be suppressed. Furthermore, the conductor in the second example embodiment may have a bent shape in conformance with a shape of a portion of the installation body that needs to be installed. Thus, flexibility in the size and the shape of the installation body in the second example embodiment is further improved.

### Advantageous Effect

First, the installation body in the second example embodiment has the same effects as those of the installation body in the first example embodiment.

The conductor provided in the installation body in the second example embodiment has a bent structure, and thus a maximum length can be suppressed. Furthermore, the conductor in the second example embodiment may have a bent shape in conformance with a shape of a portion of the installation body that needs to be installed. Thus, flexibility in the size and the shape of the installation body in the second example embodiment is further improved.

### Third Example Embodiment

A third example embodiment is an example embodiment concerned with an installation body when a transmitter includes a plurality of antennas.

### [Configuration and Operation]

A configuration example of the installation body in the third example embodiment is, for example, a configuration in which the conductor 211a of the installation body 201a illustrated in FIGS. 1 and 2 is replaced with a plurality of conductors described next. Further, a configuration example of a transmitter used in combination with the installation body in the third example embodiment is the transmitter 101a illustrated in FIGS. 1 and 2 in which the antenna 111a is replaced with a plurality of antennas described next.

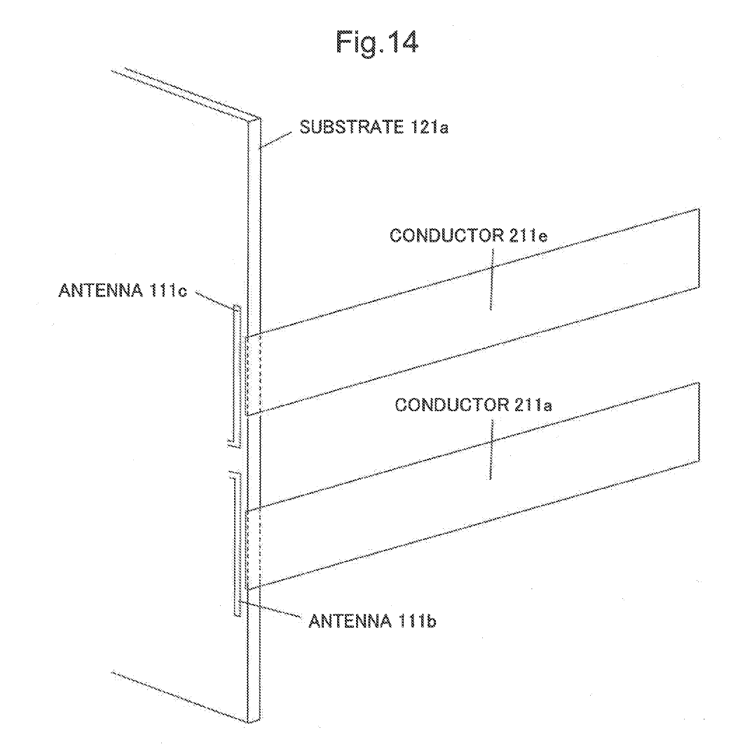

FIG. 14 is a perspective schematic diagram illustrating the conductor 211a and a conductor 211e, which is an example of a plurality of conductors provided in the installation body in the third example embodiment. FIG. 14 illustrates antennas 111b and 111c being an example of antennas of a transmitter that is combined with the installation body in the third example embodiment and is not illustrated and the substrate 121a including the antennas 111b and 111c installed therein.

A shape of the antenna 111c is a shape obtained by flipping a shape of the antenna 111b vertically. Then, the conductor 211a and the conductor 211e are disposed in the vicinity of the antenna 111b and the antenna 111c, respectively. A positional relationship between the antenna 111b and the conductor 211a is identical to a positional relationship between the antenna 111c and the conductor 211e except for that they are flipped vertically.

Note that, dimensions of the substrate, the antennas, the conductors, and the like used in the following calculation result are identical to the contents illustrated in FIG. 6 except for the above-described contents illustrated in FIG. 14. However, it is assumed that a distance between a lower end of the antenna 111c and an upper end of the antenna 111b illustrated in FIG. 14 is 9 mm.

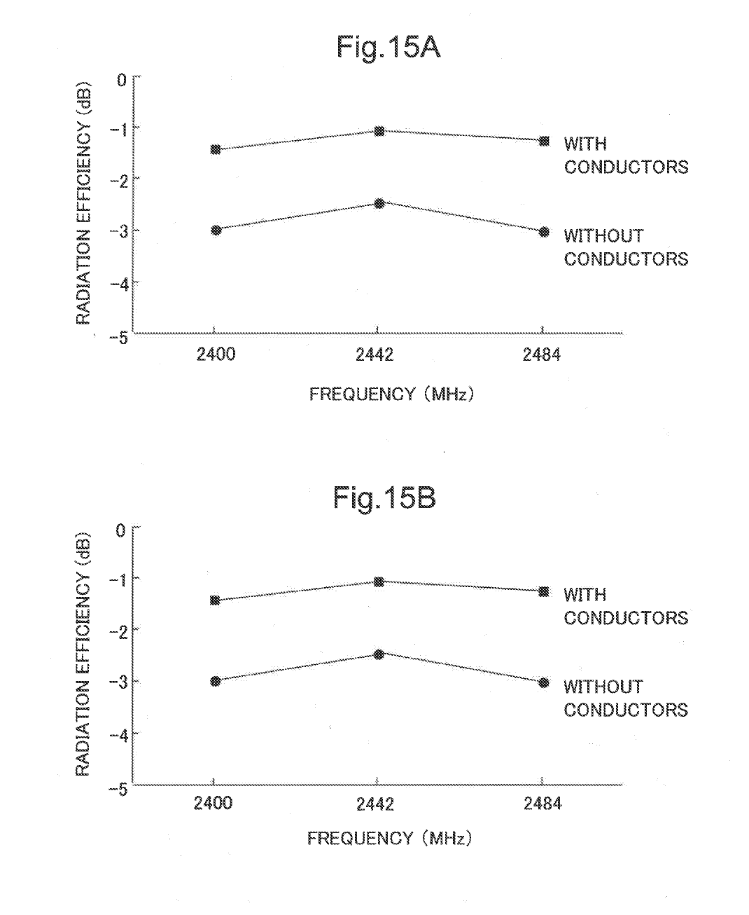

FIG. 15 is a diagram illustrating an example of a calculation result of radiation efficiency of the antenna 111b and the antenna 111c illustrated in FIG. 14. FIG. 15 (a) illustrates radiation efficiency of the antenna 111b. FIG. 15B illustrates radiation efficiency of the antenna 111c. FIGS. 15 (a) and 15 (b) each illustrate a case where the conductor 211a and the conductor 211e are installed and a case where the conductor 211a and the conductor 211e are not installed. The antenna 111b and the antenna 111c have almost identical values of the radiation efficiency in both the cases where the conductors are installed and are not installed. Further, the radiation efficiency of both of the antenna 111b and the antenna 111c improves further when the conductors are installed than when the conductors are not installed.

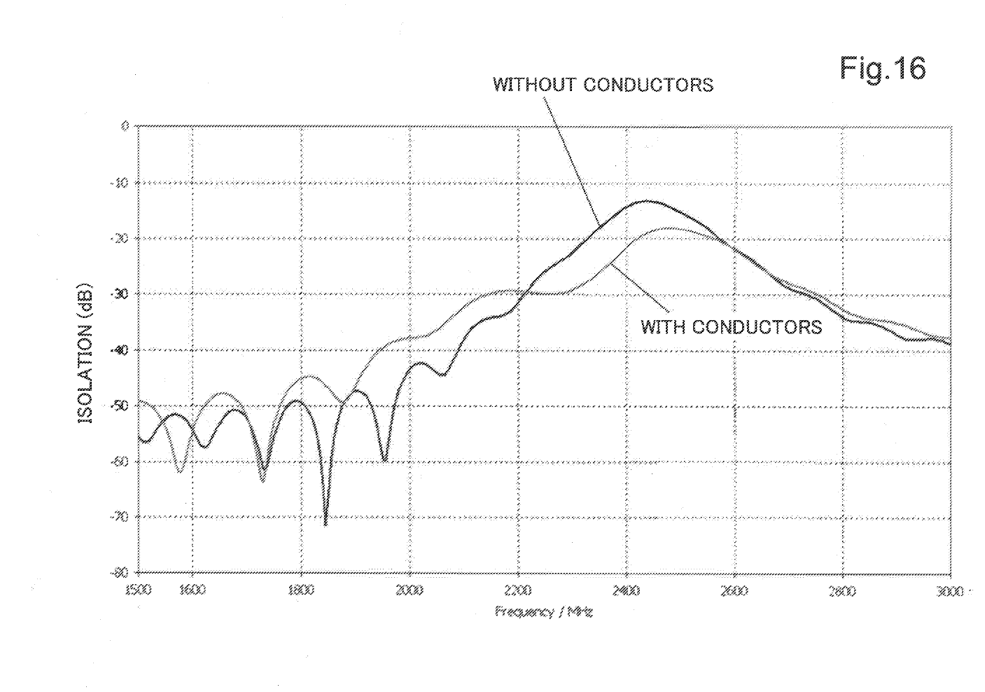

FIG. 16 is a diagram illustrating a calculation result of a frequency characteristic of an isolation, which is a leak of a signal from the antenna 111b to the antenna 111c illustrated in FIG. 14. “WITH CONDUCTORS” illustrated in FIG. 16 represents that the conductors 211a and 211e are provided as illustrated in FIG. 14. “WITHOUT CONDUCTORS” represents that the conductors 211a and 211e illustrated in FIG. 14 are not provided. As illustrated in FIG. 16, a value of an isolation in the vicinity of 2430 MHz being a frequency of a radio wave assumed to be emitted from the antennas 111b and 111c is smaller when the conductors 211a and 211e are provided than when the conductors 211a and 211e are not provided. The conceivable reason is that a radio wave flowing from the antenna 111b to the antenna 111c is suppressed by a flow of a radio wave flowing from the antenna 111b to the conductor 211a.

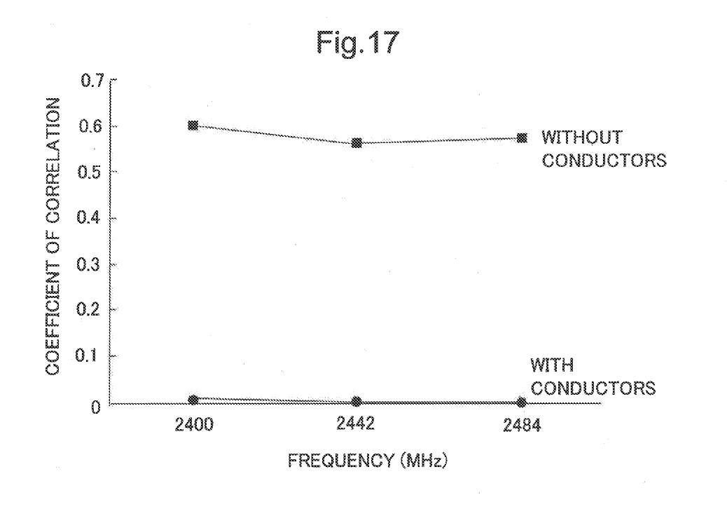

FIG. 17 is a diagram illustrating a calculation result of a coefficient of correlation between a radiation pattern of the antenna 111b and a radiation pattern of the antenna 111c. “WITH CONDUCTORS” illustrated in FIG. 17 represents that the conductors 211a and 211e are provided as illustrated in FIG. 14. “WITHOUT CONDUCTORS” represents that the conductors 211a and 211e illustrated in FIG. 14 are not provided. A great coefficient of correlation in FIG. 17 represents a stronger correlation between the radiation pattern of the antenna 111b and the radiation pattern of the antenna 111c.

As illustrated in FIG. 17, a coefficient of correlation between the radiation pattern of the antenna 111b and the radiation pattern of the antenna 111c is smaller when the conductors 211a and 211e are provided than when the conductors 211a and 211e are not provided. Therefore, it is clear that the correlation between the radiation pattern of the antenna 111b and the radiation pattern of the antenna 111c is smaller when the conductors 211a and 211e are provided.

The conceivable reason why the correlation between the radiation pattern of the antenna 111b and the radiation pattern of the antenna 111c is higher when the conductors 211a and 211e are not provided is an influence of the ground common to the antenna 111b and the antenna 111c. When the conductors 211a and 211e are not provided, the correlation between the radiation pattern of the antenna 111b and the radiation pattern of the antenna 111c is stronger due to a radiation pattern emitted from a current flowing through the common ground. On the other hand, when the conductors 211a and 211e are provided, radio waves emitted from the antennas 111b and 111c are induced to the conductors 211a and 211e due to the presence of the conductors 211a and 211e. Thus, it is conceivable that the radio waves are less affected by the current flowing through the common ground. Accordingly, the correlation between the radiation pattern of the antenna 111b and the radiation pattern of the antenna 111c is lower due to the presence of the conductors 211a and 211e.

Note that, in a case of a MIMO device, for example, it is important to suppress an isolation between a plurality of antennas and reduce a correlation between radiation patterns of the plurality of antennas in order to achieve high-speed communication. Herein, the MIMO is an abbreviation for “Multiple Input Multiple Output”. The above-described characteristic indicates that the presence of the conductors 211a and 211e is effective to achieve high-speed communication in the MIMO device.

### Advantageous Effect

First, the installation body in the third example embodiment has the same effects as those of the installation body in the first example embodiment.

The installation body in the third example embodiment with the transmitter including the plurality of antennas installed therein includes the conductor in the vicinity of each of the antennas. Each of the conductors has a length about half a wavelength of a radio wave emitted from the antenna. Thus, each of the conductors resonates by the radio wave emitted from the corresponding antenna and emits a radio wave at the same frequency. At this time, each of the conductors conceivably induces the radio wave emitted from the corresponding antenna. Thus, it is conceivable that the conductors can weaken a radio wave reaching from one of the plurality of antennas to another one of the plurality of antennas. Accordingly, the conductors can improve a leak of a signal occurring between the plurality of antennas. Furthermore, the conductors can prevent radiation patterns of radio waves emitted from the plurality of antennas and the corresponding conductors from resembling each other. The above-described characteristic indicates that the conductors are effective to achieve high-speed communication in the MIMO device.

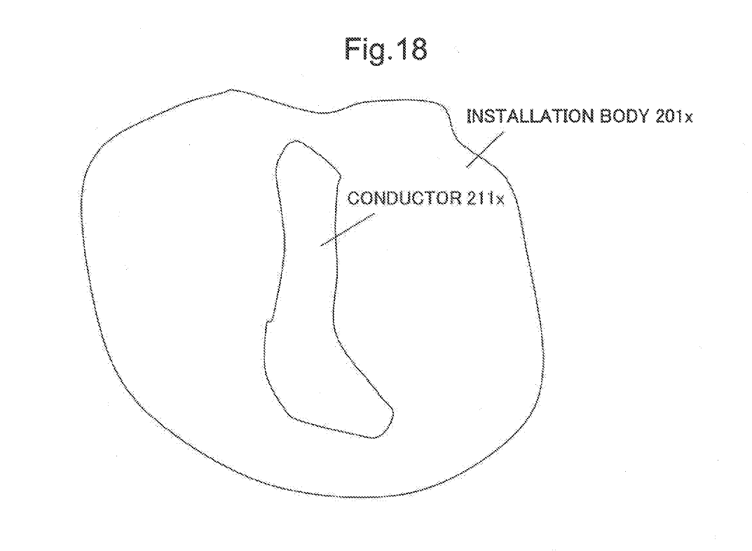

FIG. 18 is a schematic diagram illustrating an installation body 201x being an example of a minimum configuration of an installation body in the present invention.

The installation body 201x includes a conductor 211x located in the vicinity of an antenna provided in a transmitter, which is not illustrated, in a state where the transmitter is located in proximity to the installation body 201x. An induction current is generated by a drive current of the antenna in the conductor 211x. The induction current has a current component in a direction different from a direction of the drive current.

Note that, the installation body 201x and the conductor 211x can have any shape as long as the above-described conditions are satisfied.

The installation body 201x includes the conductor 211x located in the vicinity of the antenna. The induction current is generated by the drive current of the antenna in the conductor 211x. Then, a radio wave obtained by superimposing a radio wave generated by the drive current of the antenna on a radio wave generated by the induction current in the conductor 211x is emitted from the antenna and the conductor 211x in combination. Then, the induction current generated in the conductor 211x has a component in a direction different from a direction of the drive current of the antenna. Thus, a proportion of a horizontal polarized wave to a vertical polarized wave is improved in a reception position of a receiver, which is not illustrated. Therefore, the installation body can improve the probability that the receiver is able to achieve good reception of a radio wave transmitted from the transmitter regardless of an angle of installation of the antenna provided in the receiver.

Furthermore, since the conductor 211x is located outside the transmitter, both of the above-described effects and reduction in size and thickness of the transmitter can be achieved.

Thus, the installation body 201x with the above-described configuration achieves the effects described in the section of [Advantageous Effects of Invention].

The whole or part of the example embodiments disclosed above can be described as, but not limited to, the following supplementary notes.

### (Supplementary Note A1)

An installation body including:
a conductor located in a vicinity of an antenna provided in a transmitter in a state where the transmitter is located in proximity to the installation body, wherein
an induction current is generated by a drive current of the antenna in the conductor, and
the induction current has a current component in a direction different from a direction of the drive current.

### (Supplementary Note A1.1)

The installation body described in Supplementary Note A1, wherein
the induction current is a resonance current.

### (Supplementary Note A2)

The installation body described in Supplementary Note A1 or A1.1, wherein
the state of being in proximity is a state of installing the transmitter or a state of being installed in the transmitter.

### (Supplementary Note A3)

The installation body described in any one of Supplementary Notes A1 to A2, wherein
the state of being in proximity is a state of housing the transmitter or a state of being housed in the transmitter.

### (Supplementary Note A4)

The installation body described in any one of Supplementary Notes A1 to A3, wherein
a shape of the conductor is a bent shape.

### (Supplementary Note A5)

The installation body described in any one of Supplementary Notes A1 to A4, wherein
a plurality of the conductors are provided.

### (Supplementary Note A6)

The installation body according to Supplementary Note A5, wherein
each of the plurality of conductors is located in a vicinity of a different one of the antennas.

### (Supplementary Note A7)

The installation body described in any one of Supplementary Notes A1 to A6, wherein
the conductor is a plate or a film.

### (Supplementary Note A8)

The installation body described in Supplementary Note A7, wherein
the conductor is a thin plate.

### (Supplementary Note A9)

The installation body described in Supplementary Note A7, wherein
the conductor is a thin film.

### (Supplementary Note A10)

The installation body described in any one of Supplementary Notes A1 to A9, wherein
the antenna is formed on a substrate.

### (Supplementary Note A11)

The installation body described in any one of Supplementary Notes A1 to A10, wherein
the antenna is an L-shaped antenna or an inverted L-shaped antenna.

### (Supplementary Note A12)

The installation body described in any one of Supplementary Notes A1 to A11, wherein
the installation body is a cradle.

### (Supplementary Note B1)

An installation system including:
the installation body described in any one of Supplementary Notes A1 to A12; and
the transmitter.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-106391 filed on May 27, 2016, the disclosure of which is incorporated herein in its entirety by reference.

### REFERENCE SIGNS LIST

101a Transmitter
111a, 111b, 111c Antenna
121a Substrate
132a Drive unit
141a, 141b Inductor
146a Input terminal
151a Matching circuit
169a End portion
201a Installation body
211a, 211b, 211c, 211d, 211e Conductor
221a Installation place
269ba, 269bb, 269ca, 269cb, 269da, 269db End portion
279ba, 279bb, 279ca, 279cb, 279da, 279db Length
291a Long-side length
292a Short-side length
289a Point
299a, 299c Arrow

What is claimed is:

1. An installation body including:
a conductor located in a vicinity of an antenna provided in a transmitter in a state where the transmitter is located in proximity to the installation body, wherein
an induction current is generated by a drive current of the antenna in the conductor, and
the induction current has a current component in a direction different from a direction of the drive current.

2. The installation body described in claim 1, wherein
the induction current is a resonance current.

3. The installation body described in claim 1, wherein
the state of being in proximity is a state of installing the transmitter or a state of being installed in the transmitter.

4. The installation body described in claim 1, wherein
the state of being in proximity is a state of housing the transmitter or a state of being housed in the transmitter.

5. The installation body described in claim 1, wherein
a shape of the conductor is a bent shape.

6. The installation body described in claim 1, wherein
a plurality of the conductors are provided.

7. The installation body according to claim 6, wherein
each of the plurality of conductors is located in a vicinity of a different one of the antennas.

8. The installation body described in claim 1, wherein
the conductor is a plate or a film.

9. The installation body described in claim 8, wherein
the conductor is a thin plate.

10. The installation body described in claim 8, wherein
the conductor is a thin film.

11. The installation body described in claim 1, wherein
the antenna is formed on a substrate.

12. The installation body described in claim 1, wherein
the antenna is an L-shaped antenna or an inverted L-shaped antenna.

13. The installation body described in claim 1, wherein
the installation body is a cradle.

14. An installation system including:
The installation body described in claim 1; and
the transmitter.
